(19) United States
(12) Patent Application Publication
(10) Pub. No.: US 2025/0100277 A1
(43) Pub. Date: Mar. 27, 2025

(54) LIQUID EJECTION HEAD AND LIQUID EJECTION APPARATUS

(71) Applicant: CANON KABUSHIKI KAISHA, Tokyo (JP)

(72) Inventors: YOSUKE TAKAGI, Kanagawa (JP); CHIAKI MURAOKA, Saitama (JP); YASUAKI KITAYAMA, Kanagawa (JP); MASATOSHI OHIRA, Kanagawa (JP); TOMOAKI KAMAGATA, Kanagawa (JP)

(21) Appl. No.: 18/894,383

(22) Filed: Sep. 24, 2024

(30) Foreign Application Priority Data
Sep. 25, 2023 (JP) 2023-161499

(51) Int. Cl. B41J 2/14; B41J 2/175; B41J 2/18

(52) U.S. Cl. CPC B41J 2/14072; B41J 2/17523; B41J 2/17596; B41J 2/18; B41J 2202/14

(57) ABSTRACT

An object is to provide a liquid ejection head that can be mounted on a liquid ejection apparatus easily. The liquid ejection head comprises: a storing unit configured to store liquid; an element substrate having an ejection port surface in which an ejection port for ejecting liquid stored in the storing unit is formed; and an electrical circuit substrate electrically relaying a liquid ejection apparatus and the element substrate. In a posture in which the liquid ejection head is mounted on the liquid ejection apparatus, the electrical circuit substrate is located above the element substrate in the vertical direction, on the electrical circuit substrate, a connector for electrically connecting with an electrical connecting member comprised by the liquid ejection apparatus is provided, and on the electrical circuit substrate, the connector is provided only on a top surface facing in a direction opposite to the ejection port surface.

### BACKGROUND

### Field of the Disclosure

The present disclosure relates to a liquid ejection head and a liquid ejection apparatus.

### Description of the Related Art

A liquid ejection head attachable to and detachable from a liquid ejection apparatus is known. In the attaching/detaching work of a liquid ejection head, there is a case where a predetermined wiring line is connected to a predetermined electrical connection section provided on a circuit substrate arranged inside the liquid ejection head.

Japanese Patent Laid-Open No. 2021-41658 has disclosed a liquid jet head (liquid ejection head) whose circuit substrate is laminated on the top surface of a head case above a nozzle plate. The circuit substrate is provided with a connector (electrical connection section) capable of connecting a wiring member for transmitting a predetermined electric signal.

According to the configuration of Japanese Patent Laid-Open No. 2021-41658, the circuit substrate is arranged in a state of being brought down, and therefore, the connection of a wiring member to the connector arranged on the circuit substrate is implemented while reducing the height of the liquid ejection head.

With the circuit substrate disclosed in Japanese Patent Laid-Open No. 2021-41658, however, a plurality of connectors is arranged not only on the top surface of the circuit substrate but also on the undersurface, and therefore, it is difficult to connect all of the plurality of wiring members to all the connectors provided on the circuit substrate.

### SUMMARY

An object of the present disclosure is to provide a liquid ejection head capable of being easily mounted on a liquid ejection apparatus.

The liquid ejection head according to the present disclosure includes: a storing unit configured to store liquid; an element substrate having an ejection port surface in which an ejection port for ejecting liquid stored in the storing unit is formed; and an electrical circuit substrate electrically relaying a liquid ejection apparatus and the element substrate, wherein in a posture in which the liquid ejection head is mounted on the liquid ejection apparatus, the electrical circuit substrate is located above the element substrate in the vertical direction, the end portion in the longitudinal direction of the electrical circuit substrate is provided with a connector for electrically connecting with an electrical connecting member comprised by the liquid ejection apparatus, and on the electrical circuit substrate, the connector is provided only on a top surface facing in a direction opposite to the ejection port surface.

Further features of the present disclosure will become apparent from the following description of exemplary embodiments with reference to the attached drawings.

### BRIEF DESCRIPTION OF THE DRAWINGS

FIG. 1 is an exploded perspective diagram showing one example of a liquid ejection head in one embodiment;

FIG. 2 is a diagram showing one example of a connection portion between an electrical circuit substrate and an element substance in one embodiment;

FIG. 3A is a diagram showing a liquid ejection head in a first comparative example;

FIG. 3B is a diagram showing a liquid ejection head in a second comparative example;

FIG. 4A is a schematic cross-sectional diagram of a liquid ejection head in one embodiment;

FIG. 4B is a schematic cross-sectional diagram of a liquid ejection head in one embodiment;

FIG. 5 is a schematic top diagram of an electrical circuit substrate in one embodiment;

FIG. 6 is a schematic perspective diagram showing part of a liquid ejection head in one embodiment;

FIG. 7A is a VIIA-VIIA cross-sectional diagram of FIG. 6;

FIG. 7B is a VIIB-VIIBA cross-sectional diagram of FIG. 6; and

FIG. 8 is a schematic top diagram of an electrical circuit substrate in one embodiment.

### DESCRIPTION OF THE EMBODIMENTS

### First Embodiment

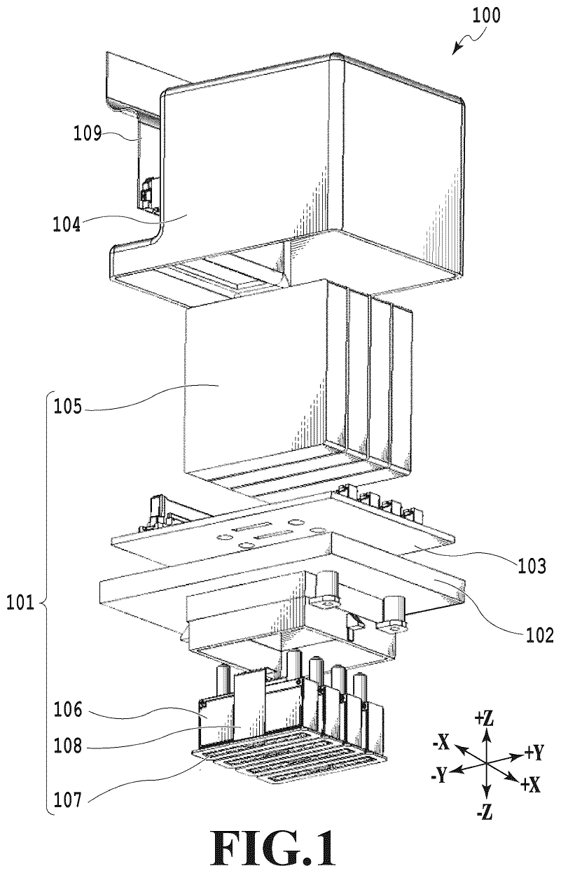

FIG. 1 is an exploded perspective diagram showing one example of a liquid ejection head 100 that can be applied to the present embodiment.

Coordinate axes in the drawings are explained. Here, explanation is given with the posture in the state where the liquid ejection head 100 is mounted on a liquid ejection apparatus not shown schematically. In the drawings referred to in the present specification, the X-direction and the Y-direction indicate two directions perpendicular to each other on a horizontal plane. The Z-direction indicates the vertical direction. The +Y-direction indicates the backward direction of the liquid ejection head 100, the −Y-direction indicates the forward direction, the −X-direction indicates the leftward direction, the +X-direction indicates the rightward direction, the +Z-direction indicates the upward direction, and the −Z-direction indicates the downward direction, respectively. The +Y-direction also indicates the downstream side in the conveyance direction of a printing medium and the −Y-direction also indicates the upstream side in the conveyance direction of a printing medium. The X-direction is called the scanning direction as appropriate. In the following explanation, unless described particularly, the upward, downward, leftward, and rightward directions indicate directions in the posture in which the liquid ejection head 100 is used in the normal state.

In the present embodiment, explanation is given on the assumption that “liquid” is ink. However, the liquid that can be used in the present embodiment is not limited to ink. That is, as the liquid, it may also be possible to use various printing liquids including a processing liquid or the like that is used for the purpose of improving the fixing property of ink in a printing medium, reducing gloss unevenness, or improving scratch resistance.

In the present embodiment, explanation is given on the assumption that “printing medium” is a sheet that is used in a general liquid ejection apparatus. However, “printing medium” is not limited as long as it is a medium capable of receiving liquid. As another example of “printing medium”, there is cloth, plastic film, metal plate, glass, ceramics, resin, wood, leather or the like.

“Printing” means not only forming significant information, such as a character and graphics. “Printing” also means forming meaningless information, such as an image or pattern. Further, “printing” is irrespective of whether or not visualization is performed so as to enable visual perception by a human being. That is, “printing” also means forming a structure for a printing medium or modifying a medium.

It is possible to freely attach and detach the liquid ejection head 100 shown in FIG. 1 to and from a liquid ejection apparatus (for example, ink jet printer) capable of performing printing for a printing medium (for example, sheet) by ejecting liquid by the so-called serial method. For example, the liquid ejection head 100 is mounted on a carriage (not shown schematically) capable of reciprocating in the scanning direction (+X-direction). It is possible for the liquid ejection head 100 to perform printing for a printing medium (not shown schematically) while reciprocating in the scanning direction (+X-direction) in the state of being mounted on a carriage.

The liquid ejection apparatus comprises a conveyance unit (not shown schematically) configured to convey a printing medium in the conveyance direction. In the present embodiment, the conveyance direction is determined to be the direction (−Y-direction) perpendicular to the scanning direction. The liquid ejection apparatus performs printing by moving the liquid ejection head 100 in the scanning direction and ejecting liquid while driving the conveyance unit to move a printing medium intermittently in the conveyance direction.

The liquid ejection apparatus comprises a control unit (for example, CPU not shown schematically) configured to control the whole apparatus, a ROM (not shown schematically) in which programs to be executed by the control unit and various parameters are stored, and a RAM (not shown schematically) that can be used as a temporary storage unit. For example, it is possible to perform printing for a printing medium by the CPU reading a program stored in the ROM, loading the program onto the RAM, and executing the program. In the present embodiment, it is also possible to circulate ink inside the liquid ejection head 100 by the CPU reading a program stored in the ROM, loading the program onto the RAM, and executing the program.

As shown in FIG. 1, the liquid ejection head 100 comprises four individual units 101 capable of ejecting liquid individually. The liquid ejection head 100 comprises a base member 102 capable of supporting all the individual units 101, an electrical circuit substrate 103 arranged on the base member 102, and a cover 104 capable of covering the electrical circuit substrate 103. In the present embodiment, the cover 104 can be attached to and detached from the base member 102. However, the cover 104 may be fixed so that the cover 104 cannot be detached easily from the base member 102.

Each of the four individual units 101 includes a sub tank 105 functioning as a storing unit capable of temporarily storing liquid to be used for printing, a channel unit 106 in which a channel is formed, and an element substrate 107, which is a semiconductor device capable of ejecting liquid. The electrical circuit substrate 103 and each of the four element substrates 107 are connected by a flexible substrate 108. That is, in the present embodiment, the four flexible substrates 108 are used.

In the present embodiment, an example is shown in which liquid is supplied to the sub tank 105 from the outside (for example, main tank not shown schematically), but a cartridge in which a predetermined amount of liquid is stored in advance may be mounted inside the liquid ejection head 100. As described above, it is also possible to supply liquid to the channel unit 106 by attaching and detaching a cartridge, which is the type that is used until it is used up and then discarded. Inside the channel unit 106, two channels are formed, which connect the sub tank 105 and the element substrate 107 fluidly.

The element substrate 107 has a plurality of energy generation elements (for example, heaters) generating energy for ejecting liquid and an ejection port surface on which an ejection port array including a plurality of ejection ports through which liquid is ejected is formed along a predetermined direction. The ejection port array is formed along the conveyance direction (Y-direction) of a printing medium. Each of the plurality of energy generation elements is provided at a position corresponding to each of the plurality of ejection ports. By the energy generation element driving, liquid droplets are ejected from the ejection port. An electric signal (ejection signal) for driving the energy generation element is generated by the above-described control unit. The ejection signal is transmitted to the electrical circuit substrate 103 from the main body of the liquid ejection apparatus via an electrical connecting member 109.

In the present embodiment, as the electrical connecting member 109, a flexible cable is used. The ejection signal received by the electrical circuit substrate 103 is transmitted to the element substrate 107 via the flexible substrate 108. The element substrate 107 is provided with a terminal capable of receiving the ejection signal. In a case of receiving the ejection signal, the element substrate 107 drives the energy generation element. In the present embodiment, liquid is ejected as described above.

Each of the four individual units 101 is assembled to the liquid ejection head 100 by being fixed to the base member 102. The surrounding of the sub tank 105 is covered by the cover 104. The cover 104 is mounted downward from above in the vertical direction and fixed to the base member 102.

In the present embodiment, the four individual units 101 are used, but the number of individual units 101 is not limited to four.

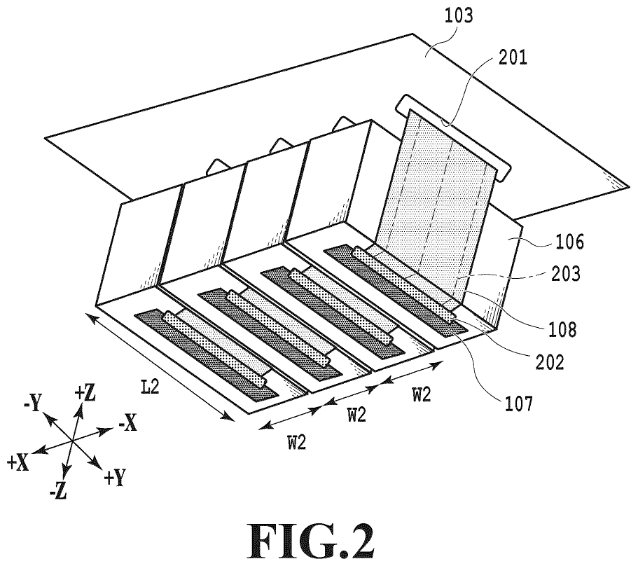

FIG. 2 is a diagram showing one example of a connection state of the electrical circuit substrate 103 and the element substrate 107 of the present embodiment.

As shown in FIG. 2, the electrical circuit substrate 103 is arranged above the channel unit 106 in the vertical direction in the state where the obverse side and the reverse side are horizontal. Because of this, the electrical circuit substrate 103 has a top surface facing upward (+Z-direction) in the vertical direction and an undersurface facing downward (−Z-direction). In the electrical circuit substrate 103, first openings 201 are formed.

The flexible substrate 108 is arranged so as to pass through the first opening 201. On the top surface of the electrical circuit substrate 103, to substantially the center in the Y-direction, the end portion (not shown schematically in FIG. 2) of the flexible substrate 108 is connected. The flexible substrate 108 passes through the first opening 201 from the top surface of the electrical circuit substrate 103 and extends along the lateral face (in FIG. 2, the face facing in the −X-direction) of the channel unit 106.

To the bottom face (in FIG. 2, the face facing in the −Z-direction) of the channel unit 106, the element substrate 107 is pasted. The flexible substrate 108 extends along the lateral face of the channel unit 106 and is bent about 90° so as to extend along the bottom face. The shape of the element substrate 107 is a rectangle having long sides and short sides in a state in a bottom view. At the bottom face (in FIG. 2, the face facing in the −Z-direction) of the element substrate 107, an electrical contact section to which the end portion of the flexible substrate 108 is connected is provided. The electrical contact section is provided so as to be along the longitudinal direction of the flexible substrate 108 at the end portion in the transverse direction of the flexible substrate 108.

In detail, the electrical contact section is configured by a plurality of terminals being arrayed so as to be along the longitudinal direction of the flexible substrate 108 at the end portion in the transverse direction of the flexible substrate 108. Inside the flexible substrate 108, a plurality of wiring lines 203 (for example, copper foils) is included. The electrical contact section is sealed by a sealing member 202 after the element substrate 107 and the flexible substrate 108 are connected electrically. On the flexible substrate 108, each individual wiring line 203 is arranged linearly along the extending direction of the flexible substrate 108.

According to the arrangement such as this, it is no longer necessary to secure a comparatively wide area for arranging the wiring lines 203 on the bottom face portion of the liquid ejection head 100. That is, it is made possible to downsize the bottom face portion of the liquid ejection head 100 and the whole liquid ejection head. As above, at the bottom face portion of the liquid ejection head 100, the wiring lines 203 are arranged linearly along the extending direction of the flexible substrate 108 without the direction in which the wiring lines 203 extend being changed by taking into consideration the downsizing and the production cost of the liquid ejection head 100. In the following, the effects of the downsizing of the liquid ejection head 100 of the present embodiment are explained by using an imaginary comparative example.

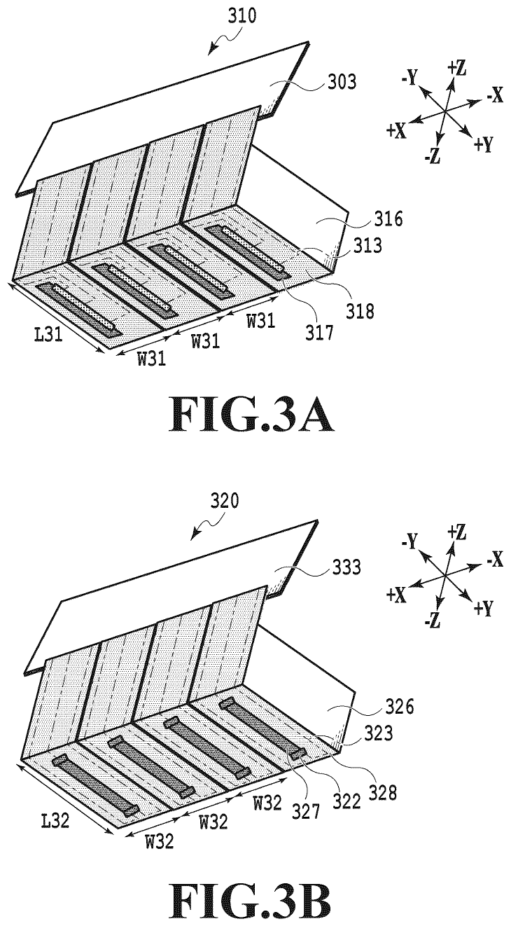

FIG. 3A is a diagram showing a liquid ejection head 310 in a first comparative example.

As shown in FIG. 3A, the liquid ejection head 310 comprises an electrical circuit substrate 303, flexible substrates 318, element substrates 317, channel units 316, and sealing members 312. The flexible substrate 318 includes wiring lines 313. The electrical circuit substrate 303 corresponds to the electrical circuit substrate 103 (see FIG. 1 and FIG. 2). The flexible substrate 318 corresponds to the flexible substrate 108 (see FIG. 1 and FIG. 2). The wiring line 313 corresponds to the wiring line 203 (see FIG. 2). The element substrate 317 corresponds to the element substrate 107 (see FIG. 1 and FIG. 2). The channel unit 316 corresponds to the channel unit 106 (see FIG. 1 and FIG. 2). The sealing member 312 corresponds to the sealing member 202 (see FIG. 2).

In the present comparative example, the end portion of the flexible substrate 318 is connected to the end portion of the electrical circuit substrate 303. Then, the flexible substrate 318 is in the state of being bent along the bottom face (the face facing in the −Z-direction) from the back face (the face facing in the −Y-direction) of the channel unit 316.

Further, the element substrate 317 has an electrical connection section provided as in the present embodiment. On the bottom face portion of the liquid ejection head 310, the wiring line 313 is in the state of extending along the depth direction (Y-direction) of the channel unit 316 and changing its orientation along the width direction (X-direction) of the channel unit 316. That is, on the flexible substrate 318 of the present comparative example, each individual wiring line 313 is not arranged along the extending direction of the flexible substrate 318, and therefore, an excess area in which the wiring line 313 changes its orientation becomes necessary compared to the flexible substrate 108 of the present embodiment. Consequently, a width 31 of the bottom face of the channel unit 316, on which the element substrate 317 is provided, becomes greater than a width W2 (see FIG. 2) of the channel unit 106, and therefore, there is a possibility that the liquid ejection head 310 becomes large in size.

FIG. 3B is a diagram showing a liquid ejection head 320 in a second comparative example. In the following, explanation of the configuration common to that of the liquid ejection head 310 (see FIG. 3A) is omitted as appropriate and different points are explained mainly.

As shown in FIG. 3B, the liquid ejection head 320 comprises an electrical circuit substrate 333, flexible substrates 328, element substrates 327, channel units 326, and sealing members 322. The flexible substrate 328 includes wiring lines 323. The electrical circuit substrate 333 corresponds to the electrical circuit substrate 103 (see FIG. 1 and FIG. 2). The flexible substrate 328 corresponds to the flexible substrate 108 (see FIG. 1 and FIG. 2). The wiring line 323 corresponds to the wiring line 203 (see FIG. 2). The element substrate 327 corresponds to the element substrate 107 (see FIG. 1 and FIG. 2). The channel unit 326 corresponds to the channel unit 106 (see FIG. 1 and FIG. 2). The sealing member 322 corresponds to the sealing member 202 (see FIG. 2).

In the present comparative example, the electrical connection section of the element substrate 327 is provided along the transverse direction (X-direction) at both end portions in the longitudinal direction of the element substrate 327. As a result of that, the wiring line 323 connected to the electrical connection section provided on the side (the side in the −Y-direction) ahead of the center of the element substrate 327 is arranged linearly.

However, the wiring line 323 connected to the electrical connection section provided on the side (the side in the +Y-direction) behind the center of the element substrate 327 extends toward the depth direction (Y-direction) of the channel unit 326. Then, the wiring line 323 changes its orientation in the transverse direction (X-direction) and then changes again its orientation toward the depth direction (Y-direction). That is, on the flexible substrate 328 of the present comparative example, each individual wiring line 323 is not arranged along the extending direction of the flexible substrate 328, and therefore, an excess area in which the wiring line 313 changes its orientation becomes necessary compared to the flexible substrate 108 of the present embodiment. Consequently, a width W32 of the bottom face of the channel unit 326, on which the element substrate 327 is provided, becomes greater than the width W2 (see FIG. 2) of the channel unit 106, and therefore, there is a possibility that the liquid ejection head 320 becomes large in size.

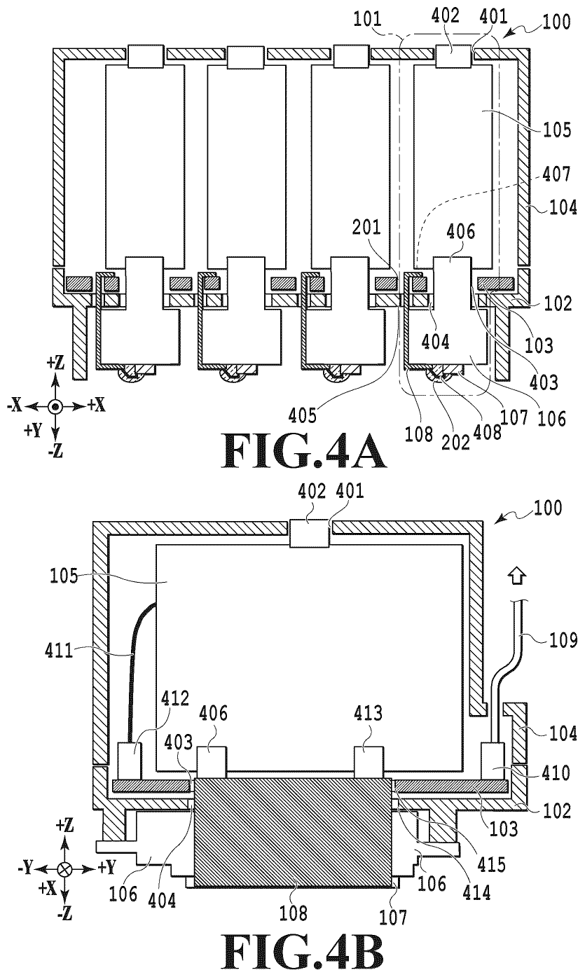

FIG. 4A and FIG. 4B are each a schematic cross-sectional diagram of the liquid ejection head 100 in the present embodiment. In FIG. 4A and FIG. 4B, the liquid ejection head 100 is shown in the state of being mounted on a liquid ejection apparatus. In FIG. 4A, the liquid ejection head 100 is cut by a cutting line passing the Y-axis and the Z-axis. In FIG. 4B, the liquid ejection head 100 is cut by a cutting line passing the X-axis and the Z-axis.

As shown in FIG. 4A, in the ceiling face portion of the cover 104, second openings 401 are formed. The sub tank 105 is provided with a supply port 402 through which liquid is supplied from a main tank (not shown schematically). The supply port 402 is provided inside the second opening 401. The electrical circuit substrate 103 is provided with third openings 403.

The base member 102 is provided with fourth openings 404 through which part of the channel unit 106 to passes and sixth openings 414 (see FIG. 4B). The channel unit 106 is provided with a supply channel 406 connected to the sub tank 105. The supply channel 406 is formed so as to penetrate through the third opening 403 and the fourth opening 404. On the top surface of the electrical circuit substrate 103, electrical connection sections 407 (specifically, a plurality of terminals) to which the end portion of the flexible substrate 108 is connected are provided. The flexible substrate 108 and the element substrate 107 are connected via a wire 408. The wire 408 is sealed with the sealing member 202.

In the state where the liquid ejection head 100 is mounted on a liquid ejection apparatus, the top surface of the electrical circuit substrate 103 is arranged in parallel to the bottom face of the element substrate 107 in which an ejection port capable of ejecting liquid is formed.

The flexible substrate 108 is arranged so as to pass from the electrical connection section 407 provided on the top surface of the electrical circuit substrate 103 through the first opening 201 provided in the electrical circuit substrate 103 and through a fifth opening 405 provided in the base member 102. The flexible substrate 108 is arranged along the lateral face and the bottom face of the channel unit 106 and connected to the wire 408. The terminal of the flexible substrate 108 and the terminal provided for the element substrate 107 are connected by wire bonding using the wire 408.

In a case where printing by the liquid ejection head 100 is performed, the liquid that is used for the printing is supplied to the sub tank 105 from a main tank (not shown schematically) via the supply port 402. In the sub tank 105, the liquid is stored temporarily. In the state where the sub tank 105 is incorporated in the liquid ejection head 100, the sub tank 105 is arranged above the electrical circuit substrate 103 in the vertical direction. The liquid stored in the sub tank 105 is supplied to the element substrate 107 via the supply channel 406.

In a case where an ejection signal for ejecting liquid is transmitted to the energy generation element provided on the element substrate 107 via the flexible substrate 108 and the wire 408, liquid is ejected from the ejection port.

As shown in FIG. 4B, on the top surface of the electrical circuit substrate 103, a first connector 410 is provided, which is capable of connecting the electrical connecting member 109 for transmitting an electric signal (for example, an ejection signal) transmitted from the main body of the liquid ejection apparatus to the electrical circuit substrate 103. In the present embodiment, the first connector 410 is provided only on the top surface of the electrical circuit substrate 103 facing in the direction (+Z-direction) opposite to the direction (−Z-direction) in which the ejection port surface of the element substrate 107 faces.

Further, in the present embodiment, the liquid ejection head 100 is configured to circulate liquid inside thereof in order to obtain a stable ejection performance even in a case where the viscosity of liquid becomes high. Inside the sub tank 105, a pump (not shown schematically) for sucking in and circulating liquid is provided. An original signal for driving the pump is generated by a pump control unit (for example, the above-described CPU, not shown schematically). The original signal is input to the first connector 410 provided on the top surface of the electrical circuit substrate 103 from the main body of the liquid ejection apparatus via the electrical connecting member 109.

On the electrical circuit substrate 103, the original signal is transmitted to a second connector 412 provided on the top surface of the electrical circuit substrate 103 via a circuit provided on the electrical circuit substrate 103. In the state where a harness 411 is connected to the second connector 412, the original signal is transmitted to a pump provided inside the sub tank 105 via the harness 411. It is possible to attach and detach the harness 411 to and from the second connector 412.

As described above, it is possible to attach and detach the liquid ejection head 100 to and from the liquid ejection apparatus. At the point in time before the liquid ejection head 100 is mounted on the liquid ejection apparatus, each of the electrical connecting member 109 and the harness 411 is in the state of not being connected to each of the first connector 410 and the second connector 412. In a case where the liquid ejection head 100 is mounted on the liquid ejection apparatus, the electrical connecting member 109 is connected to the first connector 410. Specifically, the end portion of the electrical connecting member 109 is inserted into an insertion portion of the first connector 410. In a case where the liquid ejection head 100 is removed from the liquid ejection apparatus, the end portion of the electrical connecting member 109 is pulled out of the insertion portion of the first connector 410.

Further, in a case where the liquid ejection head 100 is mounted on the liquid ejection apparatus, the harness 411 is connected to the second connector 412. Specifically, the end portion of the harness 411 is inserted into an insertion portion of the second connector 412. In a case where the liquid ejection head 100 is removed from the liquid ejection apparatus, the end portion of the harness 411 is pulled out of the insertion portion of the second connector 412.

In the channel unit 106, a collecting channel 413 for collecting liquid from the element substrate to the sub tank 105 in a case where liquid is circulated is formed. The collecting channel 413 is formed so as to pass through the sixth opening 414 provided in the base member 102 and a seventh opening 415 provided in the electrical circuit substrate 103. The sub tank 105 and the channel unit 106 are connected to each other via the supply channel 406 and the collecting channel 413.

According to the configuration such as this, in a case where a drive signal for driving the pump is input to the first connector 410 via the electrical connecting member 109, the drive signal is transmitted to the second connector 412 via a circuit provided on the electrical circuit substrate 103. Then, the drive signal is transmitted to the pump via the harness 411. In a case where the pump is driven by the drive signal, liquid is supplied from the pump to the element substrate 107 via the supply channel 406 and collected from the element substrate 107 to the pump via the collecting channel 413.

In the present embodiment, the first connector 410 is located in a comparatively narrow space inside the liquid ejection head 100. Consequently, it is necessary for a user to perform the attaching/detaching work of the electrical connecting member 109 for the first connector 410 inside this narrow space. Because of this, the easiness of the attaching/detaching work is required.

Consequently, in the present embodiment, the first connector 410 is used, which extends linearly in the vertically upward direction from the top surface of the electrical circuit substrate 103 in the state where the liquid ejection head 100 is mounted on the liquid ejection apparatus. Then, the electrical connecting member 109 is connected linearly to the first connector 410 of a linear type in the vertically downward direction from above. According to the configuration such as this, it is possible to connect the electrical connecting member 109 to the first connector 410 without necessitating any complicated work.

Further, in the present embodiment, the work to connect the harness 411 to the second connector 412 is performed after the sub tank 105 is assembled. Consequently, after the sub tank 105 is assembled, the second connector 412 is located in a comparatively narrow space inside the liquid ejection head 100. Because of this, it is necessary for a user to perform the attaching/detaching work of the harness 411 for the second connector 412 inside this narrow space. Because of this, the easiness of this attaching/detaching work is also required.

Consequently, in the present embodiment, the second connector 412 is used, which extends linearly in the vertically upward direction from the top surface of the electrical circuit substrate 103 in the state where the liquid ejection head 100 is mounted on the liquid ejection apparatus. Then, the harness 411 is connected to the second connector 412 linearly in the vertically downward direction from above. According to the configuration such as this, it is possible to connect the harness 411 to the second connector 412 without necessitating any complicated work.

Further, in the present embodiment, the first connector 410 and the second connector 412 are arranged at each of both end portions of the electrical circuit substrate 103 and the space for extending the electrical connecting member 109 and the harness 411 is secured above in the vertical direction. Consequently, by connecting the electrical connecting member 109 and the harness 411 along the vertical direction, it is possible to implement both the easiness of the attaching/detaching work and the downsizing of the liquid ejection head at the same time.

As shown in FIG. 4B, it is preferable for the first connector 410 and the second connector 412 to be provided at the end portion in the conveyance direction (Y-direction) on the top surface of the electrical circuit substrate 103. That is, on the top surface of the electrical circuit substrate 103, it is preferable for the first connector 410 and the second connector 412 to be provided at the end portion in the direction (Y-direction) intersecting the direction (X-direction) in which the liquid ejection head 100 scans in a plane. The reason is the possibility that an operator (that is, a user) interferes with the carriage is reduced in a case where the operator accesses the first connector 410 and the second connector 412 from the conveyance direction compared to a case where the operator accesses them from the scanning direction.

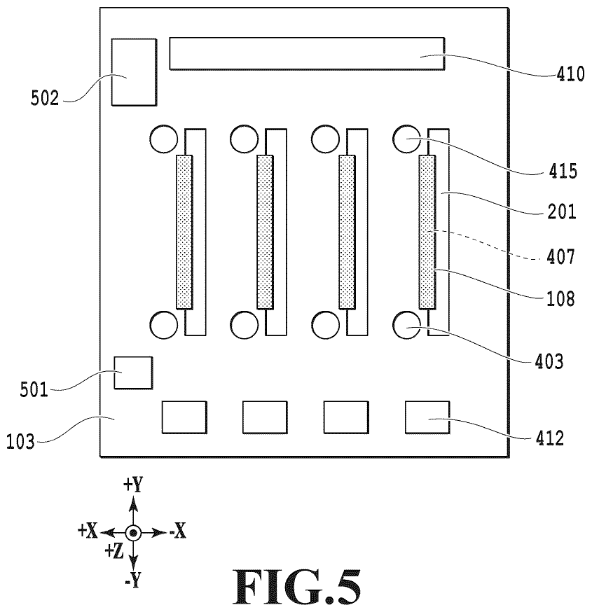

FIG. 5 is a top diagram of the electrical circuit substrate 103 that can be applied to the present embodiment.

As shown in FIG. 5, on the top surface of the electrical circuit substrate 103, electrical connection sections and electrical part mounting sections are provided. In the present embodiment, as electrical connection sections, the electrical connection section 407, the first connector 410, and the second connector 412 are provided. As electrical part mounting sections, a memory device 501 configured to record information relating to the liquid ejection head 100 and a pump drive circuit 502 configured to generate a drive signal by converting an original signal for driving a pump thereinto are provided. As described above, in the present embodiment, on the top surface of the electrical circuit substrate 103, all the electrical connection sections and all the electrical part mounting sections are aggregated.

Further, in the electrical circuit substrate 103, the third opening 403 through which the supply channel 406 (see FIG. 4) passes and the seventh opening 415 through which the collecting channel 413 (see FIG. 4) to passes are formed. It is preferable for the electrical connection section 407 configured to connect the flexible substrate 108 and the electrical circuit substrate 103 to be sealed with a sealing member (not shown schematically). According to the configuration such as this, it is possible to keep electrical safety.

As explained above, according to the liquid ejection head of the present embodiment, it is possible to mount the liquid ejection head easily on the liquid ejection apparatus.

Further, compared to the liquid ejection head in which electrical connection sections and electrical part mounting sections are provided on the top surface and the undersurface of the electrical circuit substrate, it is also possible to perform downsizing and suppress an increase in cost.

Further, the electrical connection sections and the electrical part mounting sections are aggregated on the top surface of the electrical circuit substrate 103, and therefore, it is also possible to suppress an increase in cost in the production process and reduce the time required for the work.

In addition, in a case where liquid leaks from the channel, it is necessary to prevent the liquid from reaching the electrical part mounting sections, but by the electrical part mounting sections being aggregated on the top surface of the electrical circuit substrate 103, it is possible to limit the range a user has to access to the top surface. That is, in a case where liquid leaks, it is made easy to take countermeasures for the leakage compared to the liquid ejection head in which electrical connection sections and electrical part mounting sections are provided on the top surface and the undersurface of the electrical circuit substrate.

### Second Embodiment

An object of the present embodiment is to provide a technique capable of mounting a liquid ejection head easily on a liquid ejection apparatus even in a case where the liquid ejection head lengthens. In the following, explanation of the configuration common or corresponding to that of the first embodiment is omitted by using the same symbol and name and portions different from those of the first embodiment are explained mainly.

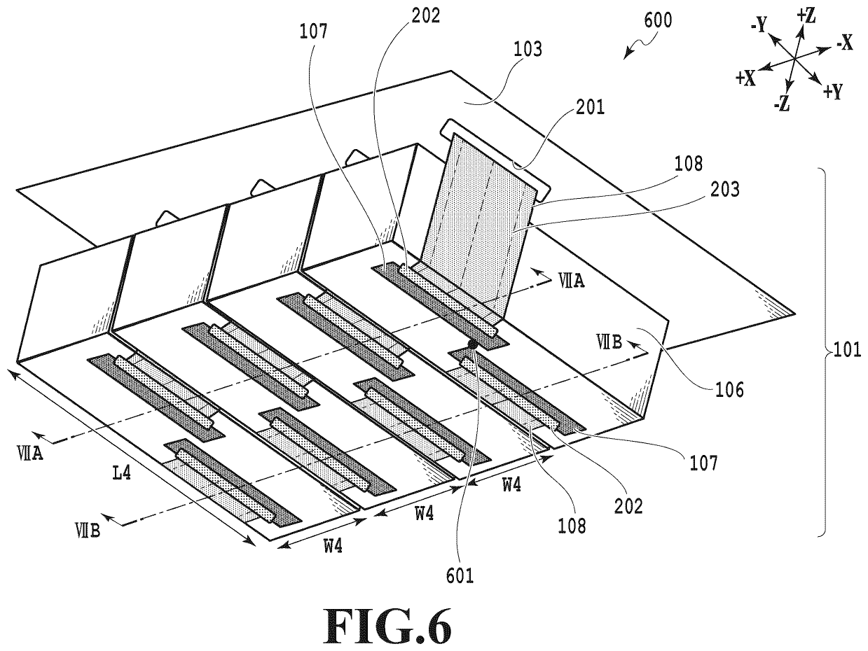

FIG. 6 is a schematic perspective diagram showing part of a second liquid ejection head 600 that can be applied to the present embodiment.

As shown in FIG. 6, on the bottom face of the one channel unit 106, the two element substrates 107 are arranged in a staggered pattern along the direction (Y-direction) in which the ejection port array extends. These two element substrates 107 are arranged so as to be point symmetrical with respect to a center point 601 located at the center of the bottom face in the channel unit 106. In the present embodiment, the two flexible substrates 108 are used because the two element substrates 107 are used.

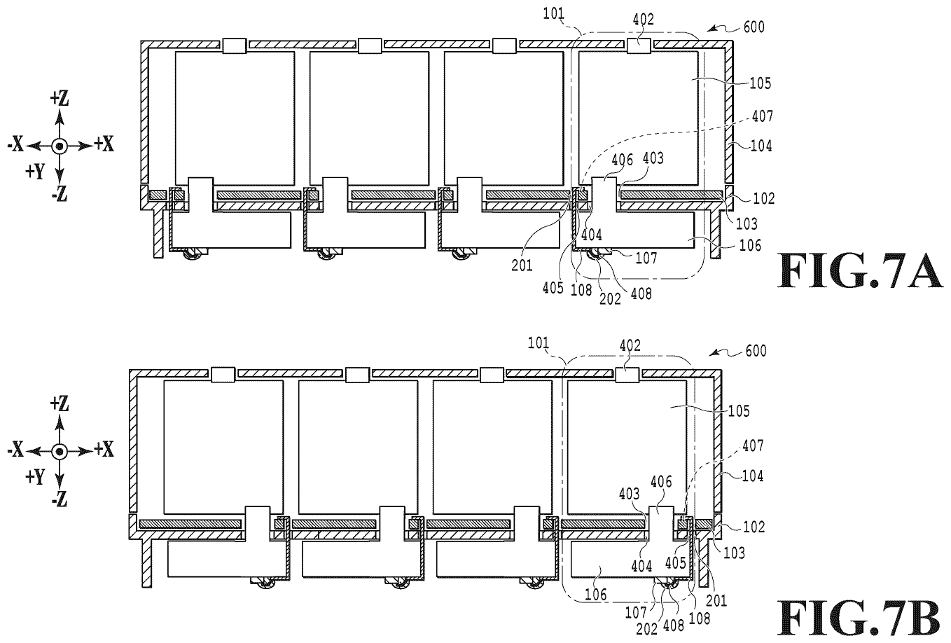

Each of the two flexible substrates 108 is provided for each of the two element substrates 107. The end portion of each of the two flexible substrates 108 is connected to the electrical contact section of the element substrate 107 as in the first embodiment. FIG. 7A is a cross-sectional diagram along VIIA-VIIA in FIG. 6.

As shown FIG. 7A, one of the two flexible substrates 108 is connected to one (in FIG. 7A, the electrical connection section 407 at the left side end portion) of the two electrical connection sections 407 provided on the top surface of the electrical circuit substrate 103. This flexible substrate 108 passes through the first opening 201 and the fifth opening 405 on the left side in FIG. 7A and is pulled out under the electrical circuit substrate 103. Then, this flexible substrate 108 extends along the left lateral face (the face facing in the −X-direction) of the channel unit 106 and is bent about 90° so as to extend along the bottom face and connected to one of the two element substrates 107 arranged on the bottom face of the channel unit 106 via the wire 408.

FIG. 7B is a cross-sectional diagram along VIIB-VIIB in FIG. 6.

As described above, the two element substrates 107 are arranged so as to be point symmetrical with respect to the center point 601 (see FIG. 6). Because of this, the two electrical connection sections 407 are also provided so as to be point symmetrical with respect to the center point 601 (see FIG. 6). Consequently, each of the two flexible substrates 108 is pulled out in the directions opposite to each other from each of the two electrical connection sections 407.

As shown in FIG. 7B, the other of the two flexible substrates 108 is connected to the other (in FIG. 7B, the electrical connection section 407 at the right side end portion) of the two electrical connection sections 407 provided on the top surface of the electrical circuit substrate 103. This flexible substrate 108 passes through the first opening 201 and the fifth opening 405 on the right side in FIG. 7B and is pulled out under the electrical circuit substrate 103. Then, this flexible substrate 108 extends along the right lateral face (the face facing in the +X-direction) of the channel unit 106 and is bent about 90° so as to extend along the bottom face and connected to the other of the two element substrates 107 arranged on the bottom face of the channel unit 106 via the wire 408.

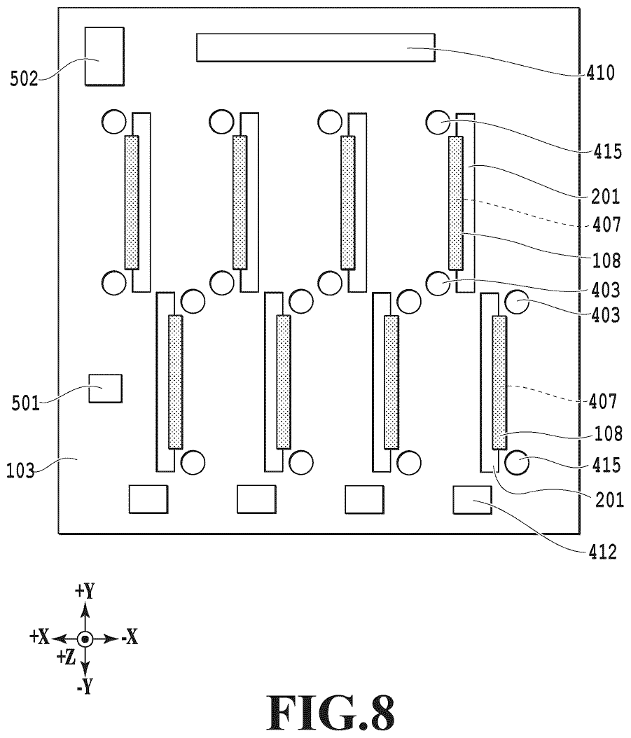

FIG. 8 is a top diagram of the electrical circuit substrate 103 that can be applied to the present embodiment.

As shown in FIG. 8, on the top surface of the electrical circuit substrate 103 of the present embodiment, at the positions corresponding to the positions of each of the two element substrates 107 (see FIG. 6) arranged in a staggered pattern, the two third openings 403 and the two first openings 201 are provided. The end portion of each of the two flexible substrates 108 (see FIG. 6) passes through each of the two first openings 201 and is connected to each of the two electrical connection sections 407 provided on the top surface of the electrical circuit substrate 103.

As in the first embodiment, in the present embodiment also, on the top surface of the electrical circuit substrate 103, the electrical connection sections and the electrical part mounting sections are aggregated. That is, the first connector 410, the second connector 412, the memory device 501, and the pump drive circuit 502 are provided only on the top surface of the electrical circuit substrate 103. The first connector 410, the second connector 412, the memory device 501, and the pump drive circuit 502 are not provided on the undersurface of the electrical circuit substrate 103. With the configuration such as this, it is also possible to obtain the same effects as those of the first embodiment.

As explained above, in the present embodiment, by arranging the two element substrates 107 in a staggered pattern, the individual unit 101 is lengthened. As described above, by comprising a plurality of common configurations for the one individual unit 101, it is possible to provide the second liquid ejection head 600, which is comparatively cheap and has a comparatively high function.

In the present embodiment, the electrical circuit substrate 103 is arranged so that the top surface of the electrical circuit substrate 103 is parallel to the ejection port surface and the electrical contact sections and the electrical part mounting sections are provided only on the top surface of the electrical circuit substrate 103. Due to this, it is possible to provide the second liquid ejection head 600, which is compact and can be attached and detached easily.

In the present embodiment, the four channel units 106 in which the two element substrates 107 are arranged in a staggered pattern are used, but the number of channel units 106 is not limited to four. Further, the number of element substrates 107 arranged in a staggered pattern for the one channel unit 106 is also not limited to two. That is, it is possible to use an arbitrary number of channel units 106 and element substrates 107.

### Other Embodiments

In the first embodiment and the second embodiment, the individual unit 101 is configured so as to be capable of ejecting ink of a single color. However, provided that liquids do not mix inside the one individual unit 101, a plurality of types of liquid may be ejected from the one individual unit 101.

Further, the four or more individual units 101 may be arranged along the X-direction (scanning direction) and the Y-direction (conveyance direction). That is, it is not necessary for the four or more individual units 101 to be arranged in a single line.

According to the liquid ejection head of the present disclosure, it is possible to mount the liquid ejection head on a liquid ejection apparatus easily.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-161499, filed Sep. 25, 2023 which are hereby incorporated by reference wherein in its entirety.

What is claimed is:

1. A liquid ejection head comprising:
a storing unit configured to store liquid;
an element substrate having an ejection port surface in which an ejection port for ejecting liquid stored in the storing unit is formed; and
an electrical circuit substrate electrically relaying a liquid ejection apparatus and the element substrate, wherein
in a posture in which the liquid ejection head is mounted on the liquid ejection apparatus, the electrical circuit substrate is located above the element substrate in the vertical direction,
the end portion in the longitudinal direction of the electrical circuit substrate is provided with a connector for electrically connecting with an electrical connecting member comprised by the liquid ejection apparatus, and
on the electrical circuit substrate, the connector is provided only on a top surface facing in a direction opposite to the ejection port surface.

2. The liquid ejection head according to claim 1, wherein
in a posture in which the liquid ejection head is mounted on the liquid ejection apparatus, the electrical circuit substrate and the element substrate are arranged horizontally and
the connector receives a vertically downward insertion of the electrical connecting member.

3. The liquid ejection head according to claim 1, further comprising:
a channel unit configured to connect the storing unit and the element substrate fluidly; and
a flexible substrate connecting the element substrate and the electrical circuit substrate electrically, wherein
the liquid ejection head ejects liquid while moving in a scanning direction and
the flexible substrate is arranged in a state of being bent along a lateral face facing in the scanning direction of the channel unit and a bottom face on which the element substrate is provided.

4. The liquid ejection head according to claim 3, wherein
in the electrical circuit substrate, a first opening through which the flexible substrate passes is provided and
the flexible substrate is arranged so as to pass through the first opening.

5. The liquid ejection head according to claim 3, wherein
the channel unit is arranged so as to pass through a second opening provided in the electrical circuit substrate.

6. The liquid ejection head according to claim 1, wherein
the connector receives, in a case where the liquid ejection head is mounted on the liquid ejection apparatus, a vertically downward insertion of the electrical connecting member corresponding to the connector.

7. The liquid ejection head according to claim 1, further comprising:
a sealing unit configured to seal an electrical connection section in the liquid ejection head.

8. The liquid ejection head according to claim 3, wherein
on the top surface, the connector is provided at an end portion in a direction intersecting the scanning direction.

9. The liquid ejection head according to claim 3, further comprising:
a pump capable of sucking in liquid, wherein
the channel unit includes a first channel for supplying liquid to the element substrate from the storing unit and a second channel for collecting liquid to the storing unit from element substrate and
in a case where the pump drives, liquid circulates between the pump and the element substrate.

10. The liquid ejection head according to claim 1, further comprising:
a channel unit configured to connect the storing unit and the element substrate fluidly, wherein
the channel unit includes a first channel for supplying liquid to the element substrate from the storing unit and a second channel for collecting liquid to the storing unit from the element substrate and
the storing unit includes a storing chamber of liquid and a pump for circulating liquid between the storing chamber and the element substrate.

11. The liquid ejection head according to claim 10, wherein
the electrical circuit substrate has a circuit converting an original signal for driving the pump into a drive signal and
the connector includes a connector for receiving the original signal and a connector for transmitting the drive signal.

12. The liquid ejection head according to claim 11, wherein
a connector for transmitting the drive signal is provided so as to be capable of receiving a vertically downward insertion of a harness transmitting the drive signal.

13. The liquid ejection head according to claim 11, wherein
on the top surface, a connector for transmitting the drive signal is provided at an end portion in a direction intersecting the scanning direction in a plane.

14. The liquid ejection head according to claim 10, wherein
a connector for receiving the original signal is provided at one end in the longitudinal direction of the electrical circuit substrate and
a connector for transmitting the drive signal is provided at the other end in the longitudinal direction of the electrical circuit substrate.

15. The liquid ejection head according to claim 10, further comprising:
a pump control unit capable of generating a drive signal driving the pump, wherein
the pump control unit is provided only on the top surface.

16. The liquid ejection head according to claim 3, having:
a plurality of the storing units;
a plurality of the element substrates; and
a plurality of the channel units configured to connect each of the plurality of the storing units and each of the plurality of the element substrates, wherein
each of the plurality of the storing units, each of the plurality of the element substrates, and each of the plurality of the channel units are provided for the one electrical circuit substrate.

17. The liquid ejection head according to claim 16, wherein
the element substrate corresponding to each of the plurality of the storing units is provided.

18. The liquid ejection head according to claim 16, wherein
each of the plurality of the element substrates is arranged in a staggered pattern along a direction intersecting the scanning direction.

19. A liquid ejection apparatus comprising:
a liquid ejection head; and
a conveyance unit capable of conveying a printing medium along a conveyance direction,
the liquid ejection head having a storing unit configured to store liquid, an element substrate having an ejection port surface in which an ejection port for ejecting liquid stored in the storing unit is formed, and an electrical circuit substrate electrically relaying a liquid ejection apparatus and the element substrate, wherein, in a posture in which the liquid ejection head is mounted on the liquid ejection apparatus, the electrical circuit substrate is located above the element substrate in the vertical direction,
the end portion in the longitudinal direction of the electrical circuit substrate is provided with a connector for electrically connecting with an electrical connecting member comprised by the liquid ejection apparatus, and
on the electrical circuit substrate, the connector is provided only on a top surface facing in a direction opposite to the ejection port surface.

20. The liquid ejection apparatus according to claim 19, further comprising:
a moving unit configured to move the liquid ejection head along a scanning direction.
